(19) United States
(12) Patent Application Publication
(10) Pub. No.: US 2019/0063389 A1
(43) Pub. Date: Feb. 28, 2019

(54) Modular Direct Injection Fuel Pump Assembly

(71) Applicant: Jason Haines, Fort Wayne, IN (US)

(72) Inventor: Jason Haines, Fort Wayne, IN (US)

(21) Appl. No.: 15/690,458

(22) Filed: Aug. 30, 2017

(51) Int. Cl. F02M 59/38; F02M 37/00; F02M 37/06; F02M 59/10

(52) U.S. Cl. CPC F02M 59/38; F02M 59/102; F02M 37/06; F02M 37/0047

(57) ABSTRACT

The present invention relates generally to a modular direct injection fuel pump assembly that can be used as a primary or auxiliary fuel pump and that can be retrofitted easily to existing engines, and preferably to engine-driven vehicles, and that can be used to provide the pressure and flow required for a direct injection system, to improve the performance of a direct injection system, as part of the conversion of a port fuel injection system to a direct injection system, or to replace or supplement an existing direct injection system.

### CROSS-REFERENCES TO RELATED APPLICATIONS

Not applicable.

### STATEMENT REGARDING FEDERALLY SPONSORED RESEARCH OR DEVELOPMENT

Not applicable

### BACKGROUND

Combustion engines, particularly combustion-engine driven vehicles such as automobiles, rely on the timely provision of combustible fuel, typically stored in a fuel tank at a location remote from the engine. Combustion engines, and particularly combustion engine vehicles, commonly utilize a fuel pump to provide fuel to the engine. The present invention relates, in its various embodiments, to an improved fuel pump to provide fuel to a combustion engine remote from the fuel tank at a desired rate of flow.

A mechanical fuel pump, which was in the past often used on carbureted engines, is driven by a camshaft or a separate shaft driven by the crankshaft. In common mechanical fuel pump designs, the pump comprises a chamber, an inlet valve to provide fuel to the chamber, and an exit valve from the chamber to (directly or indirectly) the engine, a diaphragm defining a portion of the chamber bottom, and a plunger attached at one end to the outer surface of the diaphragm near its center and attached at the other end to an actuating lever. The plunger is biased into upwards position by a biasing element, such as a spring. The end of the actuating lever opposite the connection to the plunger rests on a cam operatively connected to the shaft. As the shaft turns, the cam lobe passes under the lever and forces it up, consequentially pulling down the other end of the lever. This pulls down on the plunger, and thus the diaphragm center, creating suction within the chamber and pulling fuel into the chamber through the one-way inlet valve. As the shaft turns further, the cam lobe rotates away from the lever and biasing member forces the plunger back upwards, which provides positive pressure forcing fuel out of the chamber through the one-way outlet valve.

An electrical fuel pump, which has been used in the past in connection with carbureted and fuel injected engines, can comprise a similar arrangement of chamber, inlet and outlet valves, a diaphragm connected near its center to a plunger, and a biasing member biasing the plunger to push the diaphragm center inwards. In some electrical fuel pumps, the plunger is typically made substantially of iron or other ferromagnetic material. This type of electrical fuel pump also incorporates a solenoid switch defaulted in the “on” position. The magnetic charge of the solenoid draws the plunger outwards, pulling the diaphragm outwards, creating suction within the chamber and pulling fuel into the chamber through the one-way inlet valve. As the plunger reaches the end of a defined path of travel, it forces apart a set of contacts powering the solenoid, shutting off the magnetic field and permitting the biasing member to force the plunger back inwards, forcing the diaphragm inwards and providing positive pressure that forces fuel out of the chamber through a one-way outlet valve. As the biasing member forces the plunger inwards, the plunger ceases its disruption of the solenoid circuit and the magnetic field is reestablished, once again pulling the plunger outwards.

A “Wesco,” fuel pump, another electric fuel pump type common in vehicles, does not use a diaphragm, plunger, or solenoid. This form of electric fuel pump includes a chamber with an inlet valve on one end and an outlet valve at the other, and an electrically driven turbine-vane impeller within the chamber between the inlet valve and the outlet valve. The impeller rotates within the chamber on the basis of the rotation of an electric motor. When an electric current is applied to the electric motor, the impeller rotates within the pump chamber and a pressure difference is generated between the front and the rear of the blade groove of the impeller. Fuel is sucked into the chamber through the inlet, and pressure increased fuel is discharged from the pump chamber into the motor chamber via the outlet. In this type of fuel pump, the flow rate of fuel delivered by the pump can be altered by varying the size, shape, or configuration of the chamber or the impeller, or can be selectively altered (such as by an ECU) by varying the rate of rotation of the impeller. Other electrical fuel pump types known to the art include, as will be appreciated, roller cell, gerotor, and turbine variations.

It is relatively new, but known to the art, to attempt to increase engine performance and efficiency in a gasoline engine using “direct injection” technology, which requires increased fuel pressure compared to fuel delivery systems previously known to the art. Direct injection fuel systems apply fuel into the combustion chamber directly. Accordingly, direct injection fuel systems have a smaller window of time during piston travel to provide equivalent amounts of fuel as compared to indirect fuel pump systems. As a result, much higher pressure is required for direct injection systems to maintain flow rates adequate to apply sufficient amounts of fuel. And, since the combustion chamber has a higher operating pressure, direct injection systems require higher rail pressures to ensure that sufficient fuel is applied. Higher pressures are also preferred to achieve the level of atomization typically required by direct injection systems. Specialized fuel pumps, referred to herein as “direct injection” pumps, have been developed to handle the higher pressures demanded by gasoline direct injection systems. These pumps operate similarly to more traditional mechanical or electrical fuel pumps, but at higher pressures. Traditional injection systems introduce fuel as a spray into a port in the air intake, resulting in the delivery of a fuel-air mixture to the cylinder. Because the fuel/air mixture provided by traditional systems is only introduced into the combustion chamber during the portion of the cylinder cycle during which the intake valve is open, such systems can provide fuel nearly continuously and can operate at relatively low pressure. Direct injection systems, by contrast, introduce fuel directly to each cylinder, and can do so “on demand” to optimize the effect of fuel delivery within the cylinder on each cycle. Because direct injection systems must introduce fuel during much more compressed windows of time than traditional injection systems, direct injectors require a significantly higher pressure of delivered fuel in the common fuel rail that services them. To achieve these high pressures, a direct injection fuel pump is required. Specialized direct injection fuel pumps known to the art are, however, expensive and often difficult to produce in low volume and generally application specific. They also have heightened, and typically more expensive, design and materials requirements due to the extreme pressures to which they are subjected. As direct injection pumps are typically mechanically driven by the engine, and thus are tied to engine speed, it is a challenge in the art to increase pump flow at a given engine RPM.

Typical direct injection fuel systems, gasoline direct injection or diesel direct injection, employ two fuel pumps. A lower pressure lift pump, usually an electric pump found inside or near the fuel tank, and a high pressure fuel pump, usually a mechanical pump mounted to the engine.

### SUMMARY

The present invention relates generally to a modular direct injection fuel pump assembly that can be used as a primary or auxiliary fuel pump and that can be retrofitted easily to existing engines, and preferably to engine-driven vehicles, and that can be used to provide the pressure and flow required for a direct injection system, to improve the performance of a direct injection system, as part of the conversion of a port fuel injection system to a direct injection system, or to replace or supplement an existing direct injection system. The present invention further relates to a modular direct injection fuel pump assembly with increased reliability and durability compared to direct injection fuel pumps known to the art. The present invention further relates to a modular direct injection fuel pump assembly that can be used both as a replacement for, and as an auxiliary addition to, direct injection fuel pumps known to the art. The present invention further relates to a modular direct injection fuel pump assembly that can be easily adapted or adjusted to accommodate various levels of pressure and flow. The present invention further relates to a modular direct injection fuel pump assembly that can be easily and inexpensively manufactured compared to other direct injection fuel pumps known to the art.

Embodiments of the present invention comprise a housing containing a drive mechanism, capable of accommodating one, two, three, four or even more direct injection fuel pumps on external mounting points. The drive mechanism contained by the housing may be any drive mechanism appropriate to drive one or more direct injection fuel pumps, and can include electrical, or, hydraulic, or, preferably, mechanical drive means. The drive mechanism can be a direct drive mechanism, a fixed ratio drive mechanism, a multi-ratio drive mechanism, or a variable ratio drive mechanism. The drive mechanism may be always engaged, or a clutched drive system may be used to selectively disable one or more pumps attached to the housing. By way of example, the drive mechanism may comprise a solenoid, an electric motor, a chain, or, preferably, a camshaft. The exterior of the housing comprises a power input operatively connected to the drive mechanism. The power input is a receiver and/or translator of mechanical, hydraulic, or electrical force external to the fuel pump assembly, which is configured to deliver such force in useable form to the drive mechanism, and can include, by way of example, an electric plug electrically connected to the drive mechanism and to an external electrical system, or a pulley operatively connected to the drive mechanism and to an accessory engine drive belt. Each mounting point on the housing is configured for mechanical connection to a fuel pump, and is further configured to permit or facilitate operative connection between a fuel pump and the drive mechanism. The assembly is modular, and a desired number of fuel pumps equal to or lesser than the number of fuel pump mounting points may be mounted to the housing, and fuel pumps may be added, removed, or replaced according to the needs and desires of the user.

The fuel pump assembly of the present system can facilitate fuel rail pressures of up to 500 bar (7,250 psi) for gasoline direct injection applications and up to 3000 bar (43,500 psi) for diesel common rail direct injection applications. The fuel pump assembly of the present invention is only limited by the pump pressure capability of the modularly attached pumps. The potential fuel flow rates of the pump assembly of the present system is limited primarily by the limitations of the power input and drive mechanism—for example, shaft load in a mechanically-driven version of the present invention—as would be appreciated by one skilled in the art. As improved materials or configurations are utilized in power inputs and/or drive mechanisms, the potential fuel flow rate may improve, all within the scope and spirit of the present invention.

### BRIEF DESCRIPTION OF THE DRAWINGS

These and other features, aspects, and advantages of the present invention will become better understood with regard to the following description and accompanying drawings, where:

FIG. 1A shows a partially exploded perspective view of one embodiment of the present invention configured for use with a single fuel pump connected to an automotive engine and mounted as a primary fuel pump mechanism;

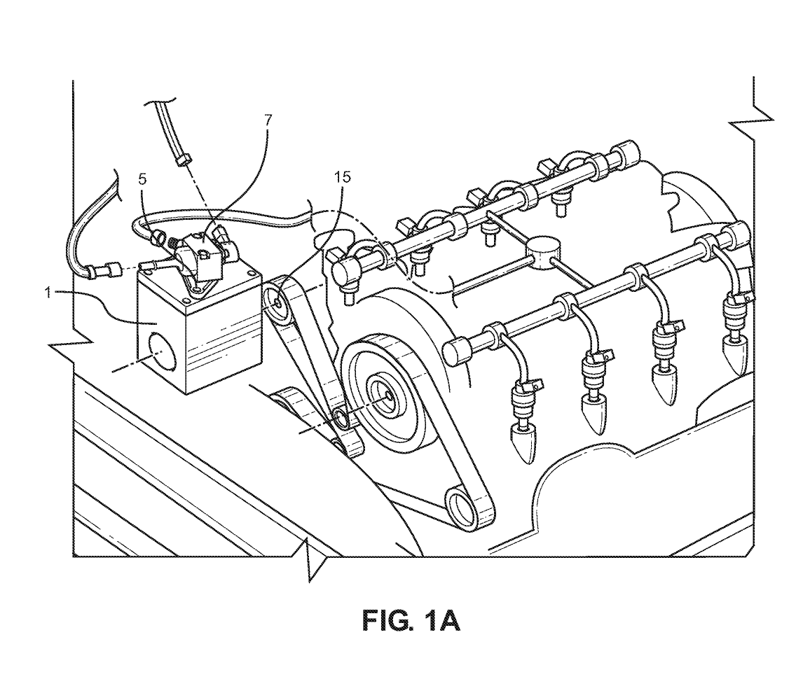

FIG. 1B shows a partially exploded perspective view of one embodiment of the present invention configured for use with a single fuel pump connected to an automotive engine as an auxiliary or secondary fuel pump mechanism;

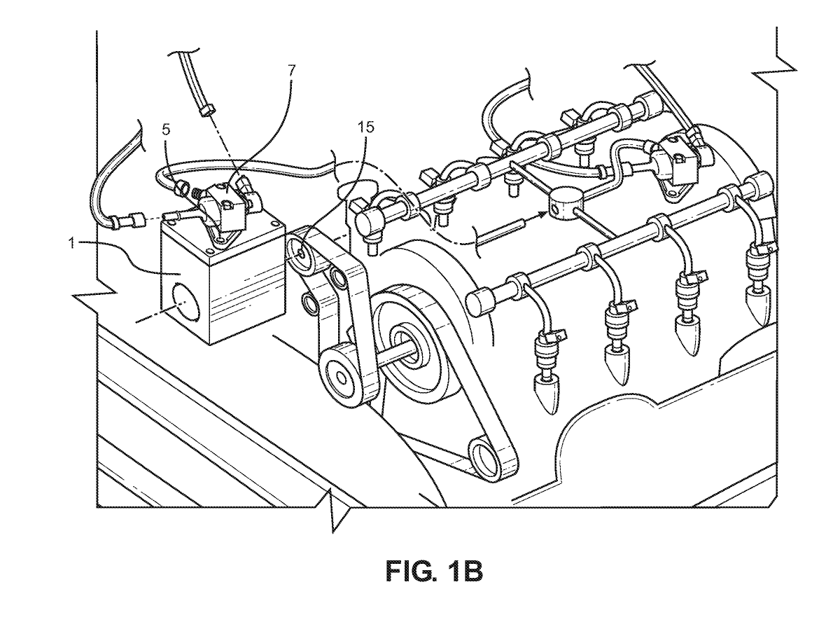

FIG. 2 shows a partially exploded view of a one embodiment of the present invention configured for use with a single fuel pump;

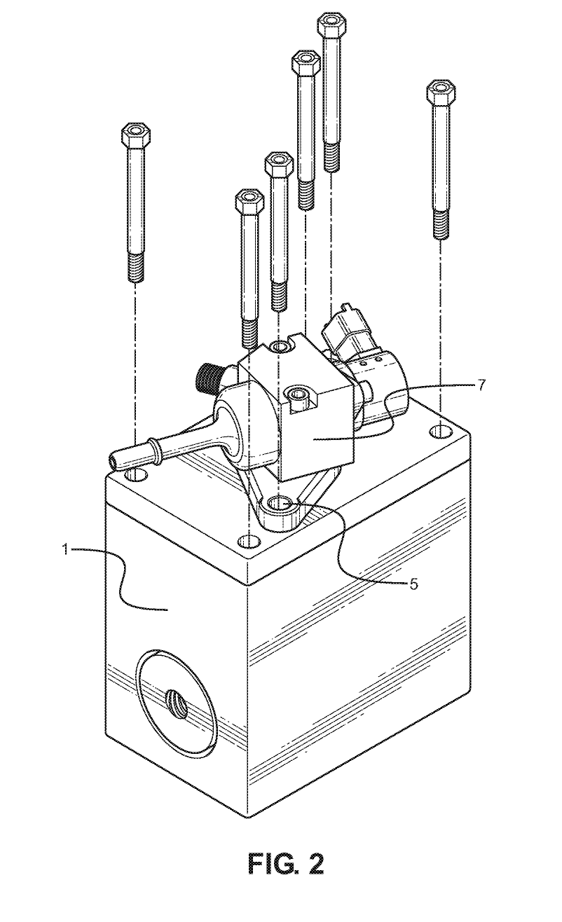

FIG. 3 shows a perspective view of an embodiment of the present invention configured for use with two fuel pumps;

FIG. 4 shows a perspective view of an embodiment of the present invention configured for use with three fuel pumps;

FIG. 5 shows a perspective view of an alternate embodiment of the present invention configured for use with two fuel pumps;

FIG. 6 shows a cross-sectional view of an embodiment of the present invention configured for use with a single fuel pump;

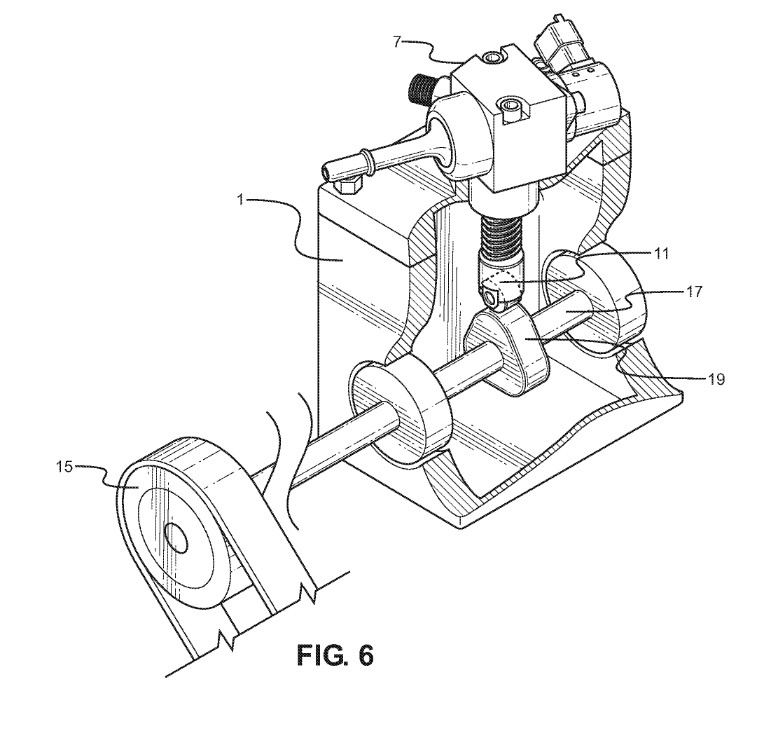

FIG. 7 shows a cross-sectional view of an embodiment of the present invention configured for use with two fuel pumps;

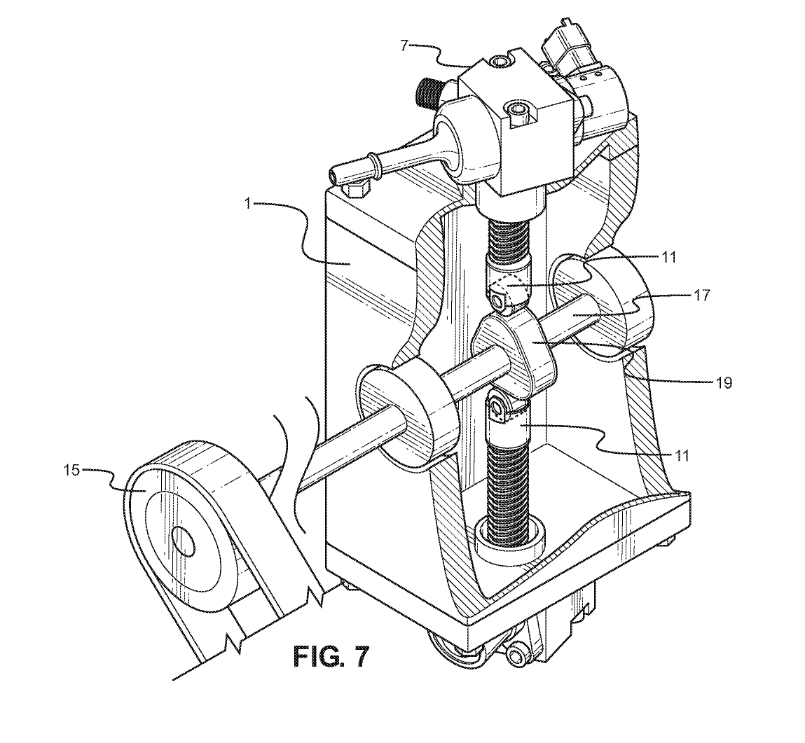

FIG. 8 shows a cross-sectional view of an embodiment of the present invention configured for use with three fuel pumps;

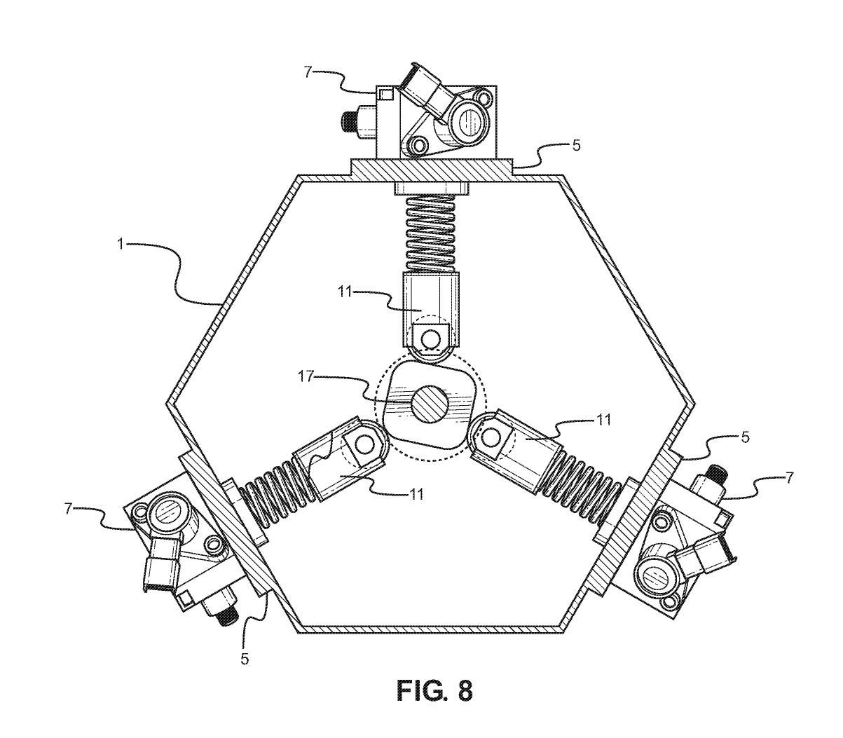

FIG. 9 shows a cross-sectional view of an alternate embodiment of the present invention configured for use with two fuel pumps.

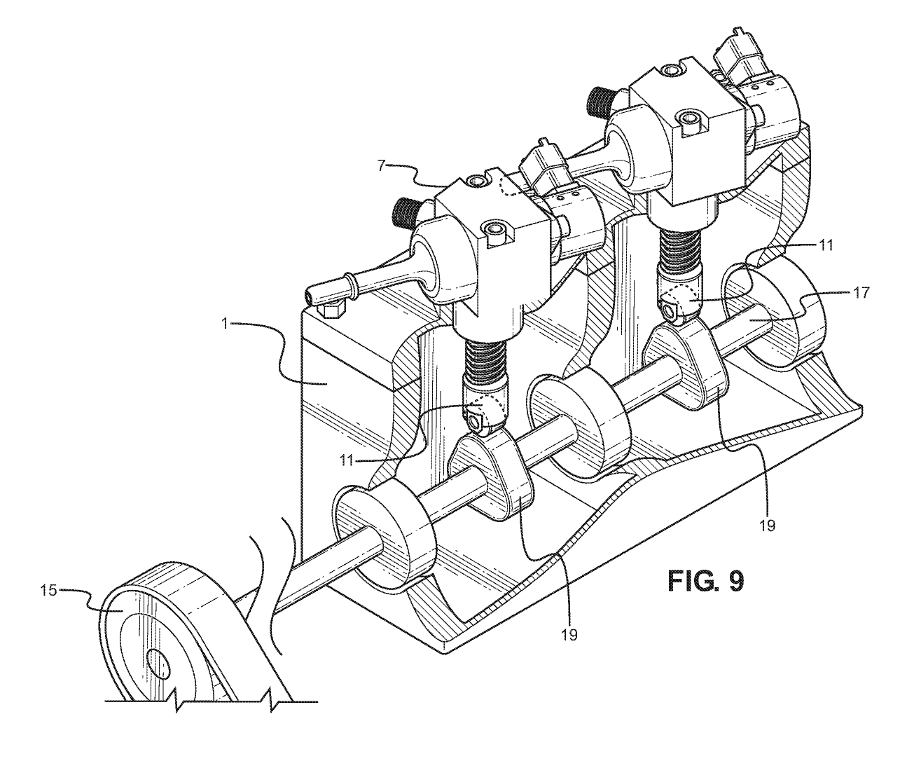

### DETAILED DESCRIPTION

The present invention comprises generally a housing 1. Preferable materials for the housing include metal and metal alloys, most preferably aluminum. The housing 1 includes at least one engine mount to facilitate permanent connection of the assembly to an engine. The housing further comprises one or more, and preferably two, three or four, pump mounting points 5 on its exterior surface. Each mounting point 5 is suitable for and configured for mechanical connection to a fuel pump 7. For example, each mounting point 5 may comprise a pattern of threaded holes compatible with a complementary pattern on a fuel pump 7 for bolt-on mechanical connection, either integral to the housing 1 or as part of a plate separately connectible to the housing 1. The pumps may all be operated by the same drive mechanism, or different individual pumps may be operated by different drive mechanisms, or a combination thereof.

The assembly of the present invention may be designed and configured for use with a wide array of commercially available fuel pumps, and may be further designed and configured to accept a variable and selectable number of fuel pumps. In one embodiment, the assembly may be configured to utilize a single fuel pump, and the housing 1 may comprise a single mounting point 5. In another embodiment, the assembly may be configured to use two or fewer fuel pumps, and the housing 1 may comprise two mounting points 5. In other embodiments, the assembly may be configured to use three, four, five, six, or fewer fuel pumps, and the housing 1 may comprise, respectively, three, four, five, or six mounting points 5. In a preferred embodiment, the assembly is configured to use three fuel pumps and the housing 1 comprises three mounting points 5. More than six mounting points may be used within the scope and spirit of this invention.

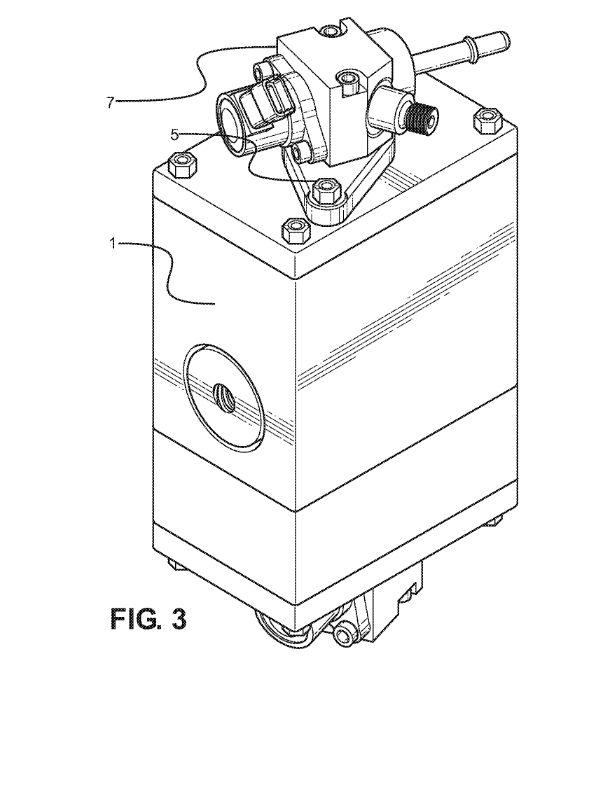

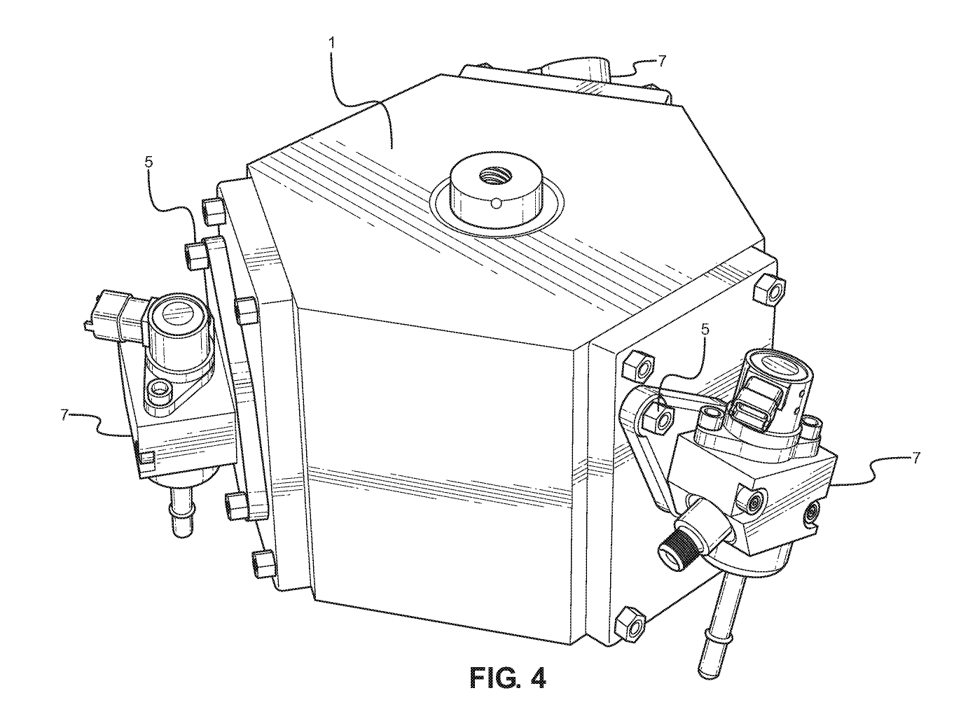

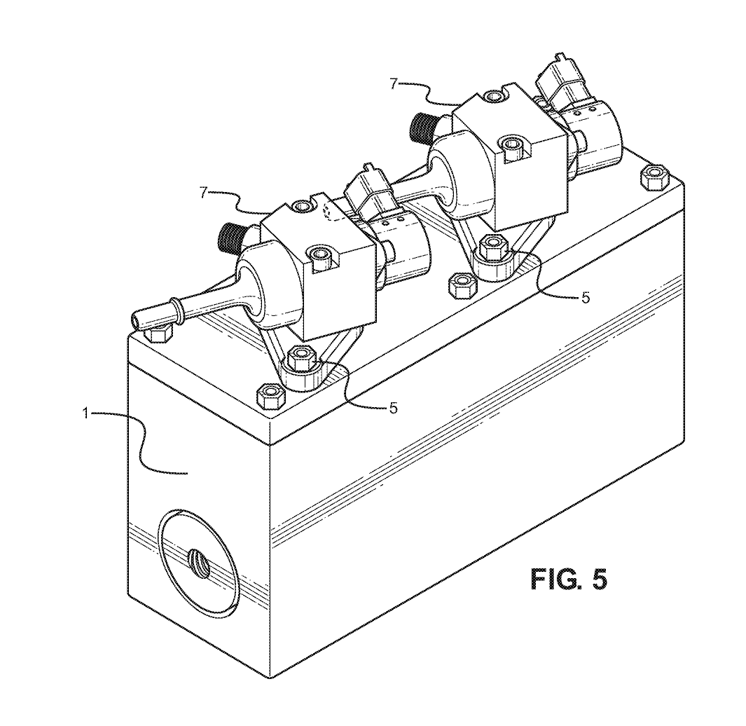

The mounting points 5 are located on the housing 1 at locations that permit space for installation of the maximum number of fuel pumps if desired, and also facilitate access between installed fuel pumps and the drive mechanism contained within the housing 1. Although a wide variety of shapes and configurations of housing 1 and mounting point 5 arrangement are possible within the scope and spirit of this invention, in a preferred embodiment the housing 1 generally comprises three legs spaced 120 degrees apart, with a mounting point 5 on each leg, as shown in FIG. 4. In another embodiment, the housing 1 comprises four legs spaced 90 degrees apart, with a mounting point 5 on each leg. In another embodiment, as shown in FIG. 3, the housing 1 comprises two legs spaced 180 degrees apart, with a mounting point on each leg 5. In yet another embodiment, the housing comprises five legs spaced 72 degrees apart, with a mounting point on each leg 5. In yet another embodiment, as shown in FIG. 5, the mounting points are serial, on a single face of the housing 1.

Generally, each mounting point 5 is further configured to permit or facilitate operative connection between a fuel pump 7 and a drive mechanism. For example, in embodiments of the present invention utilizing mechanical fuel pumps, the mounting point 5 may be configured to include a central aperture to facilitate operative connection between a plunger 11 and a fuel pump 7 on one hand, and the drive mechanism within the housing on the other. For further example, in embodiments of the present invention utilizing an electrical fuel pump, the mounting point 5 may be configured to include a plug or wires that are electrically powered by an external electrical system and compatible to attach to a fuel pump electric motor, or may alternatively be configured to include an aperture through which an electric motor contained within the housing may operatively connect to a fuel pump.

The housing 1 contains a drive mechanism. The drive mechanism can be any mechanism suitable and adapted to drive the operation of a direct injection fuel pump 7. In one embodiment, for example, the invention utilizes solenoid-driven electrical fuel pumps, and the drive mechanism comprises a solenoid. In a preferred embodiment, the invention utilizes a camshaft-driven mechanical fuel pump, and the drive mechanism comprises a camshaft 17, said camshaft 17 comprising one or more lobes 19, wherein each lobe 19 is adapted to drive a plunger 11 operatively connected to a fuel pump attached to the housing 1. In this way, the assembly's internal camshaft 17 may be configured to drive one, two, three, or more pumps mounted to the housing 1 using one, two, three, or more lobes. As will be appreciated by one skilled in the art, however, suitable drive mechanisms may alternately include belts, auxiliary motors, chains, gears, and the like.

The exterior of the housing 1 comprises a power input 15 operatively connected to the drive mechanism. The power input 15 is a receiver and/or translator of mechanical or electrical force configured to deliver such electrical or mechanical force in useable form to the drive mechanism. For example, in embodiments in which the drive mechanism is a solenoid or an electric motor, the power input 15 may be an electric plug for connection to an external electrical system, electrically connected to the solenoid or electric motor by, for example, wires passing through the housing 1 or by an indirect electrical connection utilizing wiring pre-installed in the housing 1 itself.

As will be appreciated by one skilled in the art, a variety of mechanisms and means may be used within the scope and spirit of this invention to translate electrical or mechanical force from the engine or locations in an engine-driven vehicle remote from the assembly to the power input 15, and from the power input 15 to an electrical drive mechanism.

In a preferred embodiment in which the drive mechanism is a camshaft 17, the power input 15 is a pulley, preferably a multi-ribbed pulley, operatively connected to the camshaft 17 by a shaft passing through a bearing defining an aperture at a mounting point 5, with the pulley further connected operatively to the engine by an accessory drive belt. Alternately, the camshaft 17 could be directly operatively connected to an engine. In a preferred embodiment, the camshaft 17 comprises two or more lobes 19, and each lobe 19 is offset from the others so as to cause the pump units mounted to the housing 1 to pulse at different times, thereby reducing the magnitude of pressure oscillations from the assembly.

As will be appreciated by one skilled in the art, a variety of mechanisms and means may be used within the scope and spirit of this invention to translate mechanical force from the engine to the power input 15, and from the power input 15 to a mechanical drive mechanism. And, as will be appreciated by one skilled in the art, it is desirable in each configuration to adapt the assembly so that the pulse of each pump unit is out of sync with the pulses of other pump units mounted to the assembly, to minimize pressure-based oscillations.

The assembly of the present application outputs fuel to, preferably, a common fuel rail to maintain relatively high pressure within the fuel rail compared to a traditional port fuel injection system. The assembly of the present application may selectively output fuel at pressures of up to 500 bar (7,250 psi), and preferably will selectively output fuel at pressures between 20 bar (290 psi) and 200 bar (2,900 psi). For diesel fuel, the assembly of the present invention may selectively output fuel at pressures of up to 300 0 bar (44,000 psi), and preferably will selectively output diesel fuel at pressures between 20 bar (290 psi) and 1000 bar (14,500 psi). The assembly of the present invention may also selectively output fuel at desired flow rates, as will be appreciated by one skilled in the art.

Embodiments of the present invention are modular, as a desired number of fuel pumps equal to or lesser than the number of fuel pump mounting points may be mounted to the housing, and fuel pumps may be added, removed, or replaced according to the needs and desires of the user.

The assembly of the present application in its various embodiments may further comprise, or be connected to, one or more pressure control valves. Such pressure control valves may comprise the engine's existing pressure control valve, may comprise standalone or external pressure control valves, and/or may comprise pressure control valves built into fuel pumps mounted to the housing 1. Pressure control valves could be used to implement a desired flow control strategy, such as simultaneous engagement and disengagement of all pump units, or selective engagement and disengagement of each pump unit based on desired pressure or flow parameters.

In this way, the assembly of the present application in its various embodiments provides a direct injection fuel pump system with a number of advantages compared to the prior art, including improved durability, including specifically improved durability at higher rates of flow and pressure. The assembly of the present invention is also easily retrofittable to existing combustion engine applications, such as automobiles, providing a potential replacement solution in instances where original service parts may no longer be available. As fuel pump technology continues to improve, the assembly of the present invention is further easily adaptable to be retrofitted with replacement or retrofitted fuel pumps capable of higher delivery pressures. The assembly of the present application also facilitates operation of existing combustion engines at higher fuel pressures without requiring significant engine design changes. By allowing operation at higher fuel pressures, the present invention facilitates better fuel atomization and increased injector fuel flow rates.

As will be appreciated, pumps other than direct injection fuel pumps may be attached to one or more mounting points 5 and used as part of the assembly in the same general manner of connection and operation as a direct injection fuel pump. Low pressure lift pumps, water injection pumps, engine vacuum pumps, oil scavenge pumps, oil pressure pumps, and other hydraulic pumps could each be used at one or more mounting points 5 on an assembly within the scope and spirit of the present invention. Preferably, one or more pressure control valves would be integral to a pump or pumps mounted to the assembly of the present invention, as found in most modern direct injection pumps.

A variety of control strategies may be used in connection with embodiments of the present invention. An assembly according to the present invention is preferably controlled primarily by one or more electronic control units (ECUs), particularly in embodiments in which an assembly is used in connection with a combustion-engine driven vehicle. Alternatively, embodiments of the present invention may be controlled by an electronic controller external to an ECU, or by multiple ECUs and by a single high pressure control valve, multiple high pressure control valves or a mechanical pressure control valve. In applications where the assembly of the present invention functions secondarily to a separate primary fuel pump, control strategies may include, but are not limited to: preferably, controlling the primary pump using the existing ECM and then, when the desired pressure exceeds the output of the primary pump, using an additional ECU and a high pressure control valve or valves to direct an assembly according to teachings of the present invention to phase in the needed additional fuel flow from the pump or pumps mounted on the assembly; or, alternatively, controlling both the primary and secondary pump flow simultaneously using an ECU and/or an auxiliary ECU such that both pump assemblies always provide fuel flow, although it will be understood that the primary pump and the assembly according to the teachings of the present invention may not provide equal volumes or pressures of fuel flow. In applications where an assembly according to teachings of the present invention is used as a primary fuel pump, control strategies may include, but not be limited to: preferably, controlling the high pressure control valves of all pump or pumps mounted on the assembly simultaneously such that all provide fuel flow at the same time; or, optionally, operating high pressure control valve or valves such that one pump provides fuel flow until fuel flow demand exceeds the capability of that pump, then activating a subsequent pump or pumps, simultaneously or consecutively, to provide additional fuel flow capability as needed. These primary control strategies may, as would be understood by one skilled in the art, also be applied to an assembly of the teachings of the present invention when functioning as a secondary pump.

Alternately, one or more pressure control valves operatively connected to the fuel rail may bypass excess fuel flow to maintain pressure. In this alternate control strategy, the output of a pump or pumps would not be reduced based on fuel demand, but would instead provide a fixed flow output related to pump speed, while the rail-mounted pressure control valve would return excess fuel to the fuel system. This pressure control valve or valves could be controlled by the original ECU or by a standalone ECU. As would be appreciated, primary fuel flow control could similarly be achieved using a high pressure control valve or valves integral to each fuel pump mounted to the assembly of the present invention, with supplemental fuel pressure control provided by an additional fuel pressure control valve or valves mounted to the fuel rail, or elsewhere between a high pressure pump and a fuel injector.

In other embodiments in which pumps are in operative connection to a transmission, CVT, or other speed control device, control strategies might include running one or more pumps at a fixed speed, such speed being fixed in relation to the engine speed; running all pumps at a substantially similar speed, such speed being variable based upon factors and conditions selected by a user; running one or more pumps at different speeds, such speeds being fixed in relation to engine speed; running one or more pumps at different speeds, such speeds being variable based upon factors and conditions selected by a user; and running one or more pumps sequentially or alternatingly.

Fuel flow and pressure control can also be achieved using a combination of controlling the mechanical speed of the pump(s) and the use of a high pressure control valve (or valves).

In alternate embodiments, the housing 1 may comprise multiple passages to selectively accommodate low- or high-pressure fuel flow. In some embodiments, the drive mechanism may be lubricated, such lubrication comprising an internal self-contained lubrication system, or a shared lubrication system in which the drive mechanism is lubricated with oil from the engine, as would be appreciate by one skilled in the art.

As will be appreciated, the foregoing describes only specific embodiments of the present invention, and modifications and/or changes can be made thereto without departing from the scope and spirit of the invention, the embodiments being illustrative and not restrictive. cm What is claimed is:

1. A modular direct injection fuel pump assembly comprising:
(a) a housing comprising an engine mount and one or more mounting points;
(b) within the housing, a drive mechanism; and
(c) at least one direct injection fuel pump mounted to at least one of said mounting points, wherein said direct injection fuel pump is operatively connected to said drive mechanism.

2. The direct injection fuel pump assembly of claim 1, wherein said drive mechanism is operatively connected to a combustion engine, said operative connection between said drive mechanism and said combustion engine comprises a pulley, said drive mechanism comprises a camshaft comprising one or more lobes, and said operative connection between said camshaft and said direct injection fuel pump comprises a plunger mechanically linking at least one lobe of said camshaft operatively to said direct injection fuel pump.

3. The direct injection fuel pump assembly of claim 2 comprising two mounting points, wherein one direct injection fuel pump is mounted to each of said mounting points, said camshaft comprises two or more lobes, and each of said direct injection fuel pumps is operatively connected to said camshaft, said operative connection comprising a plunger.

4. The direct injection fuel pump assembly of claim 3, wherein each mounting point is separated from each other mounting point by approximately 180 degrees.

5. The direct injection fuel pump assembly of claim 3, wherein each mounting point is in-line with each other mounting point.

6. A modular direct injection fuel pump assembly comprising:
(a) a housing comprising an engine mount and three or more mounting points, wherein each of said mounting points comprises a central aperture;
(b) within the housing, a drive mechanism; and
(c) at least one direct injection fuel pump mounted to at least one of said mounting points, wherein said direct injection fuel pump is operatively connected to said drive mechanism through said central aperture.

7. The direct injection fuel pump assembly of claim 6, wherein said drive mechanism is operatively connected to a combustion engine.

8. The direct injection fuel pump assembly of claim 7, wherein the operative connection between said drive mechanism and said combustion engine comprises a pulley.

9. The direct injection fuel pump assembly of claim 8, wherein said drive mechanism comprises a camshaft and said operative connection between said camshaft and said direct injection fuel pump comprises a plunger mechanically linking at least one lobe of said camshaft operatively to said direct injection fuel pump.

10. The direct injection fuel pump assembly of claim 9, wherein said camshaft comprises three or more lobes.

11. The direct injection fuel pump assembly of claim 10, wherein one direct injection fuel pump is mounted to each of said three mounting points, and each of said direct injection fuel pumps is operatively connected to said camshaft, said operative connection comprising a plunger.

12. The direct injection fuel pump assembly of claim 11, wherein each mounting point is separated from each other mounting point by approximately 120 degrees.

13. A modular direct injection fuel pump assembly comprising:
(a) a housing comprising an engine mount and three or more mounting points;
(b) within the housing, a drive mechanism; and
(c) at least one direct injection fuel pump mounted to at least one of said mounting points, wherein said direct injection fuel pump is operatively connected to said drive mechanism.

14. The direct injection fuel pump assembly of claim 13, wherein said drive mechanism is operatively connected to a combustion engine, said operative connection between said drive mechanism and said combustion engine comprises a pulley, said drive mechanism comprises a camshaft comprising three or more lobes, and said operative connection between said camshaft and said direct injection fuel pump comprises a plunger mechanically linking at least one lobe of said camshaft operatively to said direct injection fuel pump.

15. The direct injection fuel pump assembly of claim 14 comprising three mounting points, wherein one direct injection fuel pump is mounted to each of said three mounting points, said camshaft comprises three or more lobes, and each of said direct injection fuel pumps is operatively connected to said camshaft, said operative connection comprising a plunger.

16. The direct injection fuel pump assembly of claim 15, wherein each mounting point is separated from each other mounting point by approximately 120 degrees or less.

17. The direct injection fuel pump assembly of claim 14 comprising four mounting points, said camshaft comprises four or more lobes, and wherein one direct injection fuel pump is mounted to each of said four mounting points, and each of said direct injection fuel pumps is operatively connected to said camshaft, said operative connection comprising a plunger.

18. The direct injection fuel pump assembly of claim 17, wherein each mounting point is separated from each other mounting point by approximately 90 degrees.

19. The direct injection fuel pump assembly of claim 14 comprising five mounting points, said camshaft comprises five or more lobes, and wherein one direct injection fuel pump is mounted to each of said five mounting points, and each of said direct injection fuel pumps is operatively connected to said camshaft, said operative connection comprising a plunger.

20. The direct injection fuel pump assembly of claim 19, wherein each mounting point is separated from each other mounting point by approximately 72 degrees.
